(19) United States
(12) Patent Application Publication
(10) Pub. No.: US 2019/0236701 A1
(43) Pub. Date: Aug. 1, 2019

(54) SYSTEM AND METHOD FOR TRADING WITH MULTIPLE DELIVERY DATES

(71) Applicant: Christopher Petruzzi, San Clemente, CA (US)

(72) Inventor: Christopher Petruzzi, San Clemente, CA (US)

(21) Appl. No.: 16/333,587

(22) PCT Filed: Sep. 15, 2016
(86) PCT No.: PCT/US2017/051933

§ 371 Date: Mar. 14, 2019

Related U.S. Application Data
(60) Provisional application No. 62/394,970, filed on Sep. 15, 2016.

(51) Int. Cl. G06Q 40/04; G06Q 20/08

(52) U.S. Cl. CPC G06Q 40/04; G06Q 20/085

(57) ABSTRACT

The disclosed embodiments relate to systems and methods that let traders in securities place orders to simultaneously buy (or sell) shares in a company with delivery on an early date and then sell (or buy) shares in the same company for delivery at a later date. IN one embodiment, the method includes placing an order by a first party at a time T to sell (or buy) securities through an exchange, wherein the order contains a schedule that defines a time T+X for the delivery specified by the order to occur and a time T+X+Y for the delivery of the reverse of the order to occur, wherein the same securities are to be purchased (or sold) by the first party. Next, the exchange receives an order from a second party to buy (or sell) the securities and sell (or buy) the same securities according to the schedule. The two orders are then matched, after which confirmations of the trade are then sent to both parties. The exchange uses an intermediate custodian to consummate the transactions by making deliveries according to the schedule. As a result, the securities and cash are delivered at a time T+X and the deliveries for the reverse of the order takes place at time T+X+Y.

### FIELD OF INVENTION

The present invention generally relates to the field of securities trading. More particularly, the disclosed embodiments relate to a computer system and processes for enabling computer systems to execute trading of securities with multiple delivery dates.

### BACKGROUND

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Investors trade securities for many reasons and with many motivations. In addition to the primary motivation of yielding appreciation in share price, there are a number of ancillary benefits to stock ownership. For example, some investors desire to own a particular company's stock primarily to collect dividends. Other investors may have less interest in the dividends but more interest in the voting rights associated with the stock. Dividend rights and voting rights are both associated with particular time-frames during which the investor must own the shares to enjoy the rights. Existing stock exchanges do not always provide an efficient and cost effective way for investors to engage in securities transactions so that they maximize these ancillary ownership benefits.

### BRIEF DESCRIPTION OF THE DRAWINGS

FIG. 1A illustrates a block diagram of the interactions between computers to execute the flow of securities and cash for a two-party transaction in accordance with an embodiment of the invention using an intermediate custodian to hold both money and securities.

FIG. 1B illustrates a block diagram of the interactions between computers to execute the flow of securities and cash for a two-party transaction in accordance with an embodiment of the invention using an intermediate custodian to hold securities but not to hold money.

FIG. 2 illustrates a block diagram of the interactions between computers to execute the flow of securities and cash for a three-party transaction with one party that buys for delivery on the earlier date and sells for delivery on the later date, a second party that only sells for delivery on the earlier date, and a third party that only buys for delivery on the later date in accordance with an embodiment of the invention.

FIG. 3 illustrates a block diagram of the interactions between computers to execute the flow of securities and cash for a three-party transaction with one party that sells for delivery on the earlier date and buys for delivery on the later date, a second party that only buys for delivery on the earlier date, and a third party that only sells for delivery on the later date in accordance with an embodiment of the invention.

FIG. 4 illustrates a block diagram of a system comprising an arrangement of computers for trading with multiple delivery dates in accordance with a two-party transaction embodiment of the invention.

FIG. 5 illustrates a block diagram of a system comprising an arrangement of computers for trading with multiple delivery dates in accordance with a three-party transaction embodiment of the invention.

FIG. 6 illustrates a block diagram of a system comprising an arrangement of computers for trading with multiple delivery dates in accordance with an alternative three-party transaction embodiment of the invention.

FIG. 7 illustrates a flow chart of a computer implemented process for trading with multiple delivery dates in accordance with an embodiment of the invention.

FIG. 8 is a high level block diagram showing an information processing system useful for implementing one embodiment of the present invention.

### SUMMARY OF THE INVENTION

This section is intended to provide a summary of certain exemplary embodiments and is not intended to limit the scope of the embodiments that are disclosed in this application.

In one embodiment, the disclosed invention relates to a computer system for executing the trading of securities. The method includes placing an order by a first party at a time T to sell (or buy) securities through an exchange, wherein the order contains a schedule that defines a time T+X for the delivery specified by the order to occur and a time T+X+Y for the delivery of the reverse of the order to occur, wherein the same securities are to be purchased (or sold) by the first party. Next, the exchange receives an order from a second party to buy (or sell) the securities and sell (or buy) the same securities according to the schedule. The two orders are then matched, after which confirmations of the trade are then sent to both parties. The exchange uses an intermediate custodian to consummate the transactions by making deliveries according to the schedule. As a result, the securities and cash are delivered at a time T+X and the deliveries for the reverse of the order takes place at time T+X+Y.

These and other advantages and features of disclosed embodiments, together with the organization and manner of operation thereof, will become apparent from the following detailed description when taken in conjunction with the accompanying drawings.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner. As used herein, the term “Exchange” means any electronic network which allows the orders of Sellers (Buyers) to be filled with orders of Buyers (Sellers).

The disclosed embodiments relate to systems and methods for trading with multiple delivery dates, and in particular, to trading systems where participants can simultaneously make transactions on opposite sides in the same security for different delivery dates.

The trading of stocks and other securities has become increasingly automated by electronic trading systems in recent years, so stock exchanges are parts of networks of computers which communicate information.

Securities represent shares in corporations, and those corporations will sometimes have corporate actions which give special rights to the owner of the security at close of day on a particular date. Those rights have more value to some investors than to other investors. The disclosed embodiments make it less costly and less risky for investors to make transactions which results in those rights being owned by those who value them most highly.

Under current market structure, there are ways for an investor to implement a transaction that give the investor control over the particular date on which they buy or sell a security. However there is excess cost and risk involved with such transactions. For instance, each participant would need to make two separate orders (a buy and a sell) and pay exchange fees and also lose money on the spread on both of those orders. For example, an investor could buy stock and sell an “in the money” call option. Alternatively, the investor could buy stock, hold it overnight and sell it the next morning. However, since the price changes of the “in the money” call option will not exactly follow the price changes of the stock, the result is a certain level of risk (as well as the costs of two transactions) to the two parties. Similarly, holding the stock overnight without a contract to sell has risks and costs.

Another disadvantage of this approach is that since the contra party does not know that the buy (sell) is linked with a sell (buy), the contra party may be concerned that the trader is a toxic trader who has information or analysis which indicates that the stock price is likely to rise (fall) in the next couple of minutes. Consequently, the contra party needs a higher spread to compensate for the risk that the price will change in an adverse way in a very short time, which raises the costs of the transaction.

The disclosed embodiments solve this problem by providing computer trading system and method that enables an investor to simultaneously buy (or sell) a security for one delivery date and sell (or buy) the same security for a different delivery date. As a result, the contra party knows that the buy is linked with a sell, knows that this is just to capture corporate action from one day, and therefore has less risk in offering a lower spread. The result is less cost. In addition, the above-described risks are reduced with the disclosed embodiments. Also, the large stock exchanges (NYSE, NASDAQ, and BATS) are very efficient at processing large numbers of transactions. By limiting the transaction to just one large stock exchange, economies in data processing are achieved.

In more detail, the delivery of money and securities in a securities transaction takes place at a time after the transaction has been made. In the U.S. this is normally two days, which means that the time for delivery is T+2 days, where T is the date of the transaction. Proposals have been made to change this to T+0, meaning that the delivery of securities and money would take place at some later time the same day that the transaction was made.

In accordance with the disclosed embodiments, the delivery of securities and money could take place with any delay X, where X is the amount of time by which the delivery occurs later than the transaction. As used herein, X is in days, but could potentially be any unit of time. Thus, there is one set of buy and sell transactions for delivery on T+X and a second set of buy and sell transactions for delivery on T+X+Y. Y can be any amount of time, which is a positive or a negative amount of time, with a limit of −X. This method could be applied to any unconventional dates for delivery, X and Y, even if X is some amount of time other than the normal delivery of securities.

In a first embodiment, the exchange sends one set of Buy and Sell transactions to clearing at time T but holds the other set of Buy and Sell transactions for a later date and sends those to clearing Y amount of time after the Buy and Sell for the earlier date are sent to clearing. Therefore, the Buy and Sell for the later date would have delivery at T+X+Y, where T+X is the normal delay for clearing and Y is the amount of time by which the later transactions are past the earlier transactions.

Clearing is the process by which funds are transferred from buyers to sellers and share ownership is transferred from sellers to buyers. In the U.S. clearing usually takes place through a custodian, DTCC, which is a private company owned by its member institutions. NSCC, a subsidiary of DTCC may be the custodian in practice. Custodians hold stock and possibly also hold money. Custodians receive instructions from clients' brokers and exchanges to transmit and receive stock and money to and from DTCC. DTCC matches those instructions with the various contra parties and then sends stock and money to custodians. As used herein, the term “custodian” will mean any institution which holds securities and/or money for a client. Under this definition, the term “custodian” therefore includes banks and similar institutions. As used herein, the term “intermediate custodian” will mean a custodian which is owned or controlled by the exchange or which has made an agreement satisfactory to the exchange to not sell, lend, or otherwise transfer or encumber securities which have been delivered to it at time T+X but which are required for a second delivery at time T+X+Y. The intermediate custodian may be the regular custodian of the party which buys for delivery at time T+X if it has made a satisfactory agreement with the exchange. The intermediate custodian could also be used to hold money for payment for securities which would be delivered in the future. Due to the generic nature of money, failure to pay is less frequent than failure to deliver, and the exchange is likely to require less control of the holder of money; thus the exchange may be satisfied with a regular custodian for this purpose.

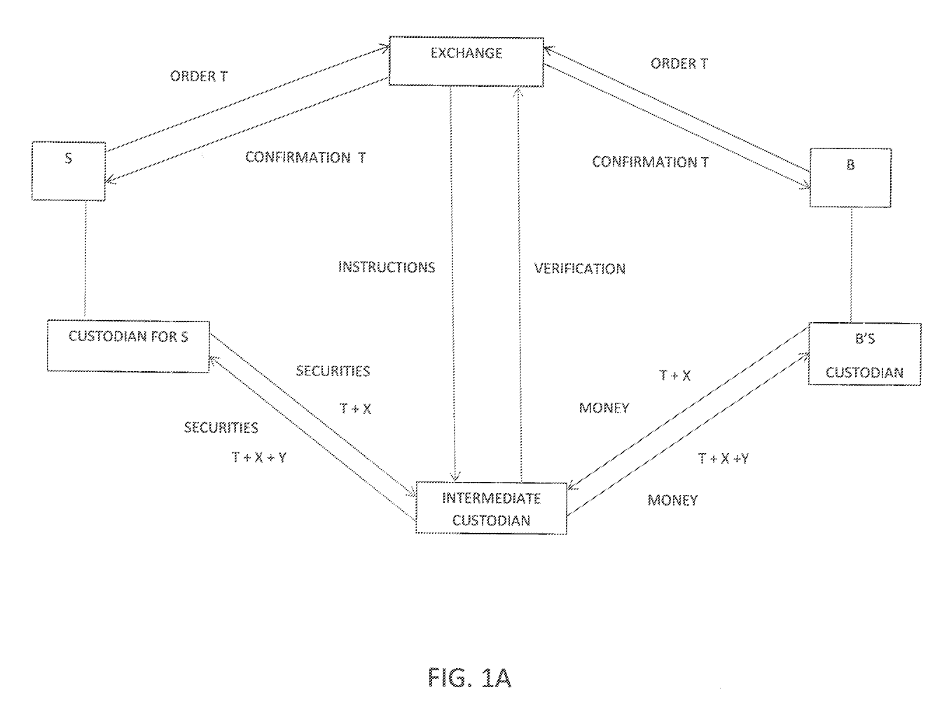

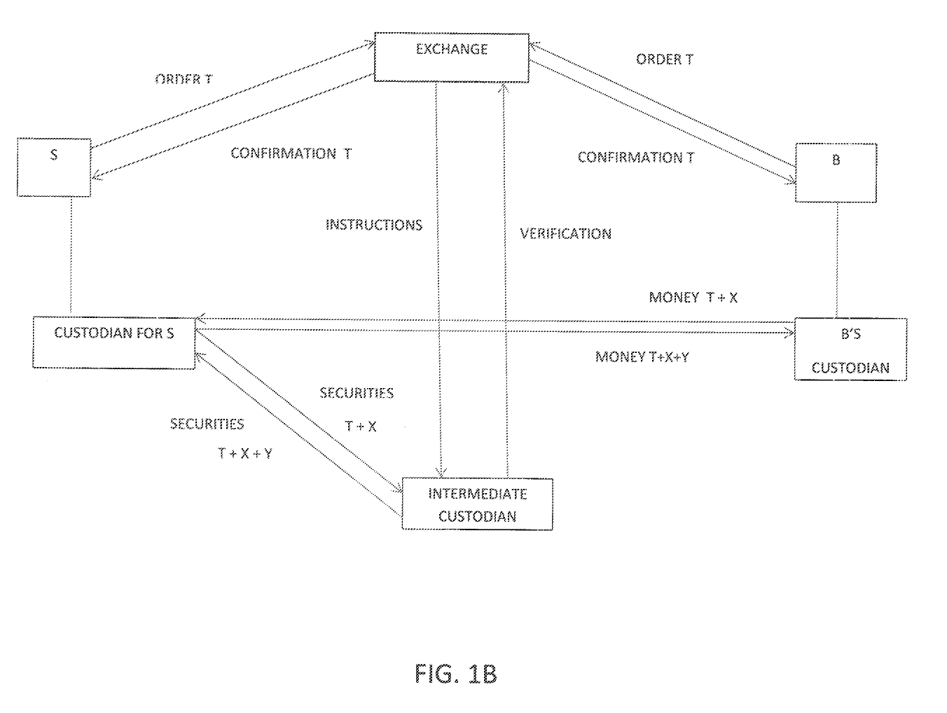

FIG. 1A illustrates a block diagram of the interactions between computers to execute the flow of securities and cash for a two-party transaction in accordance with an embodiment of the invention. FIG. 1B illustrates a block diagram of the interactions between computers to execute the flow of securities and cash for a two-party transaction in accordance with an embodiment of the invention using an intermediate custodian to hold securities but not to hold money. In one example of the embodiment shown in FIG. 1A, an investor (seller), who doesn't care about voting rights, sells his stock briefly to a buyer who does want voting rights on a particular day. The same investor simultaneously makes a transaction with the same buyer under which the buyer will deliver the stock back to the investor one day after the voting rights have vested. In FIGS. 1A, and 1B, the system 10 shows that the seller (S) 12, places an order at a time T with an exchange, which is processed by a computer controlled by the exchange 14. This order is represented by the arrow labeled “Order T.” T is the time of the transaction, which is in days in this example, but T could be in other units of time. Also on the same day T, the exchange 14 sends a confirmation (“Confirmation T”) back to the seller 12. As described above, the exchange as used herein, could be any electronic network which allows the orders of sellers (buyers) to be filled with orders of buyers (sellers). The order placed by S is typically a limit order; however, there may be circumstances where other kinds of orders, such as market orders or stop orders are used with the disclosed embodiments. The price on a limit order may be quoted in terms of a difference between the transaction for the earlier date and the transaction for the later date. Hence, someone may quote Buy (Sell) for the early date and Sell (Buy) for the later date at a difference D, where D may be a positive or a negative amount. This would be one quoted difference for the two transactions.

Also on day T, a buyer (B) 16 places an order (Order T) with the exchange 14 and the exchange 14 sends the buyer B a confirmation on the same day. It is noted that in FIG. 1A the seller 14 is a seller for the first delivery date (T+X) and the buyer 16 is a buyer for the first delivery date (T+X). The computer controlled by exchange 14 also sends instructions to a computer controlled by an intermediate custodian 18 and the computer controlled by intermediate custodian 18 sends a verification back to the exchange 14. In some cases verification can be performed by a broker, a custodian or the customer.

The intermediate custodian would be an entity controlled by the stock exchange or having a contractual obligation or other duties to the exchange which require that the securities held by the intermediate custodian not be sold, encumbered, lent, or otherwise made unavailable during the time period between T+X and T+X+Y. Consequently, the intermediate custodian could be the regular custodian for the buyer or seller if that regular custodian agrees to arrangements which are satisfactory to the exchange to guarantee that the security will be available at T+X+Y. The intermediate custodian would also perform the normal duties of a custodian so that voting rights and rights to dividends which are may be due to the holder of record between T+X and T+X+Y would be received by the buyer and interest (if any) on money held would accrue to the seller. This means that the intermediate custodian would report to the corporation or other entity which issued a security that the buyer is the holder of record. The intermediate custodian would also report ownership of the security to the buyer's regular custodian. At T+X+Y, the intermediate custodian would deliver the security to the regular custodian of the seller or to any other custodian designated by the seller.

A computer controlled by a custodian for the seller 20 is in communication with the seller 12 and has custody of the seller's securities. At time T+X the custodian for S takes the following actions: delivers the securities to the intermediate custodian 18, and, if required, records that delivery with the corporation that issued the securities. At time T+X+Y the intermediate custodian delivers the securities back to the custodian 20 and, if required, records this delivery with the issuing corporation.

The computer controlled by a buyer's custodian 22 is in communication with the buyer 16. At time T+X, computer controlled by a B's custodian 22 delivers payment for the securities to the intermediate custodian 18 in FIG. 1A. In the embodiment shown in FIG. 1B, computer controlled by a B's custodian 22 delivers the payment to S's regular custodian. The result in both embodiments (FIGS. 1A and 1B) is that on day T+X the seller no longer owns the securities and the buyer owns the securities. It should be noted that an important role of the intermediate custodian is to keep B from having control of the securities. The Seller and the exchange need to know that the securities will be delivered back to the Seller at T+X+Y. They do not want B to have the ability to sell or encumber the securities in the interim. Having the intermediate custodian record the new ownership with the issuing corporation is sufficient for B's purposes.

At time T+X+Y the intermediate custodian 18 transfers the securities back to the computer controlled by a custodian for the seller 20, as shown by the arrow “T+X+Y.” Also, at time T+X+Y, the computer controlled by intermediate custodian 18 transfers funds for payment of the securities to computer controlled by a B's custodian 22 in FIG. 1A. In the embodiment shown in FIG. 1B, S's regular custodian 20 transfers funds for payment of securities to B's custodian. The result is that in both embodiments (FIG. 1A and FIG. 1B) on day T+X+Y the seller 12 again owns the securities and the buyer 16 no longer owns the securities.

The order to sell a security at the earlier date would require identification of the availability of that security to be delivered. Then, when that security is delivered at the earlier date, it would go to the intermediate custodial account on T+X as shown in FIG. 1A. That intermediate custodial account would be: 1) an account controlled by the exchange in which the exchange keeps separate custody of securities for beneficial ownership of the Buyer but for delivery in completed transactions; or 2) an account for the initial buyer, but for which the exchange receives verification or other satisfactory assurance of continuous availability; or 3) any other custodial account which provides beneficial ownership for the buyer but for which the exchange receives verification or other satisfactory assurance of continuous availability. Hence, as shown in FIG. 1A, the Intermediate Custodian receives communications from the exchange and also sends confirmations of availability to the exchange.

The intermediate custodian for cash does not need to be the same intermediate custodian as the one holding securities. Due to the generic nature of cash, failure to pay is much less frequent than failure to deliver. Consequently, the exchange may not require extra assurance of availability of cash as is required for the securities, so the money may go to the seller's normal custodian without the use of an intermediate custodian. Alternatively, the money could go to an intermediate custodian as shown in FIG. 1A.

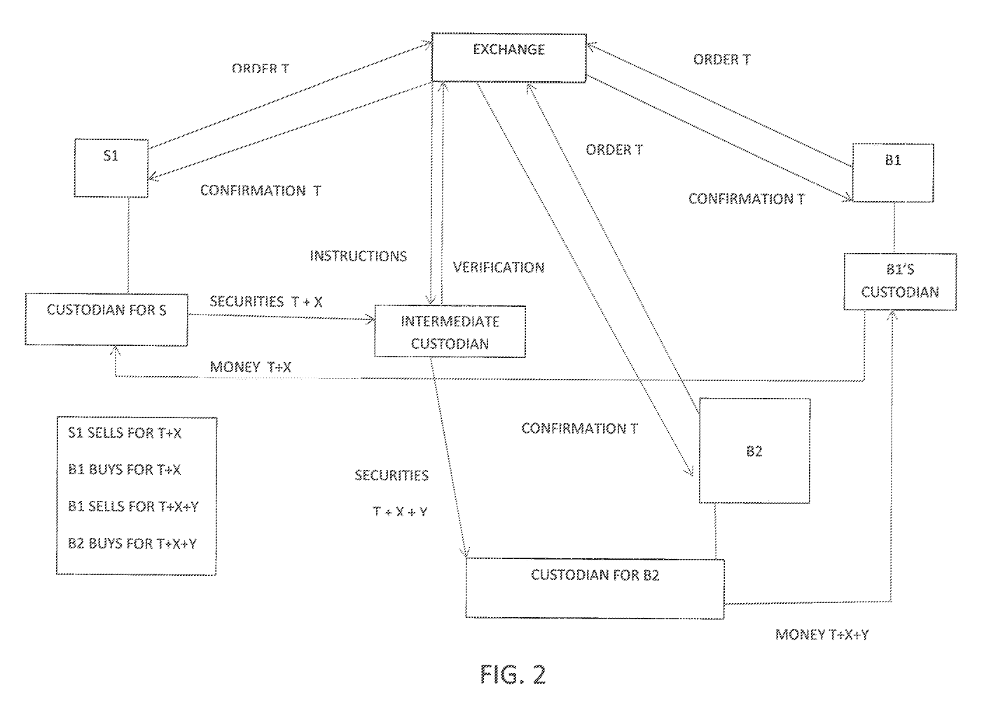

The two-party embodiment described in FIG. 1A, requires that someone who owns the stock is willing to sell it for one day with a simultaneous agreement to re-acquire the security after one day. However there might be a shortage of such owners. One solution to this problem is a three-party embodiment, which allows the transaction to occur when one party is a natural seller at the first date and the third party is a natural buyer who wants to own the stock for a long period of time, but is willing to wait a day for delivery. This scenario is referred to as a “three-party embodiment with the buyer doing two sides”, which is shown in FIG. 2.

In more detail, in a second embodiment, if one party makes a limit order to Buy (Sell) for delivery on one date and Sell (Buy) on a later date, then the two parts to the limit order will be filled by two separate parties. The first part of the fill by the separate parties would state a price for that part of the fill. This transaction would be conditional on a fill by another party that was entered at a price which makes the total price paid by the two separate parties equal to or better than the price quoted in the original limit order. That is, in order for a market order to transact with a limit order, the market order must give a price equal to, or better, than the limit order. One example of how this works is the simple transaction of “Sell 100 shares of ABC stock at $50.” Then the buyer could buy the 100 shares of ABC at $50 or higher. It would only be higher under unusual circumstances such as the two limit orders interacting with each other. Now assume a more complicated transaction in which a participant wants to get the corporate action. The participant wants to buy 100 shares of ABC for delivery at T+X and simultaneously sell 100 shares of ABC for delivery at T+X+Y. The participant is willing to pay up to $0.75 per share to get the corporate action. Then they would send an order “buy 100 ABC for T+X and sell 100 ABC for T+X+Y with the sell no more than $0.75 lower than the buy.” Another party could take the contra side of this transaction with a sell at $50 while a third party agrees to a buy at $49.25 or higher. Unlike the buyer in FIG. 1A who simultaneously enters into a transaction to sell, these two buyers will be concerned with the prices of their own transactions, and not with the difference between those two prices. Consequently, the seller's quote of a difference between the prices for delivery on T+X and T+X+Y would be integrated into the main quotations of prices for the security on the exchange, but may contain a tag indicating that they are part of an order to simultaneously buy and sell and may be eligible for a different price for execution.

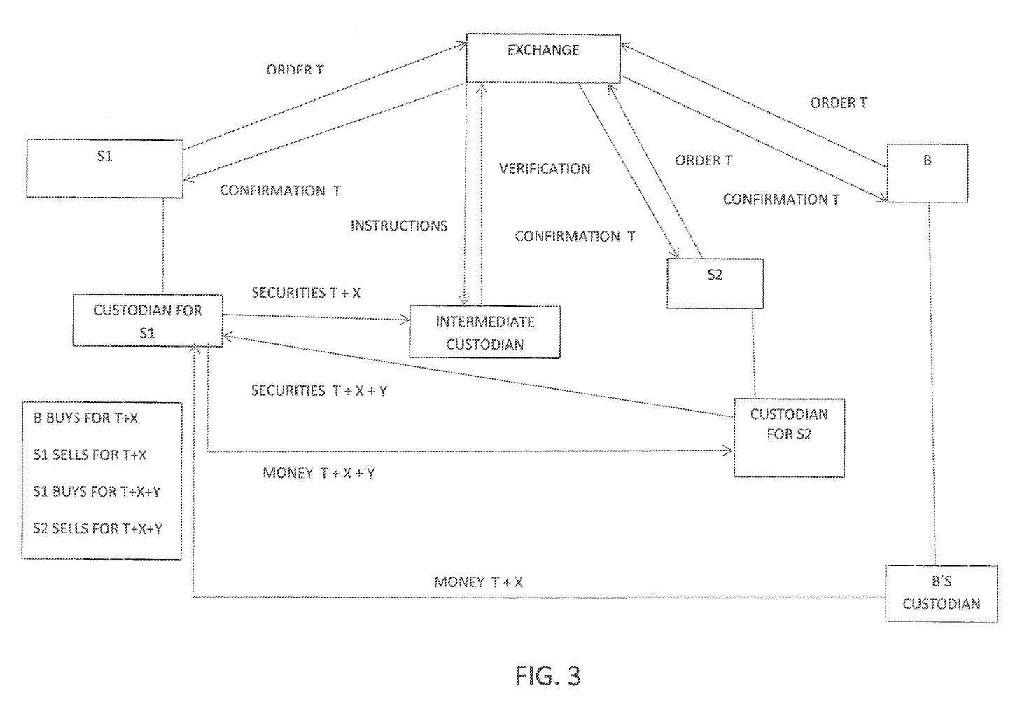

One example of this embodiment is shown in FIG. 2. In particular, FIG. 2 illustrates a block diagram of the interactions between computers to execute the flow of securities and cash for a three-party transaction with one party that buys for delivery on the earlier date and sells for delivery on the later date, a second party that only sells for delivery on the earlier date, and a third party that only buys for delivery on the later date in accordance with an embodiment of the invention. In FIG. 2, there is one seller and two different buyers on opposite sides of the transaction. The first buyer is also the seller on the second transaction. That enables the first buyer to own the security for the record date of the corporate action but to be locked into a sale which requires subsequent delivery to the second buyer. Another example of a three-party transaction is shown in FIG. 3, discussed below. In particular, FIG. 3 illustrates a block diagram block diagram of the interactions between computers to execute the flow of securities and cash for a three-party transaction with one buyer and two different sellers on opposite sides of the transaction. The first seller is also the buyer on the second transaction. That enables the first seller to not own the security for the record date of the corporate action but to be locked into a sale under which that seller would subsequently receive return of the security.

Referring now to FIG. 2, a system 24 shows that the seller for the first delivery date (S1) 26, places an order at a time T with computer controlled by an exchange 28. This order is represented by the arrow labeled “Order T.” T is the time of the transaction. Also on the same day T, the computer controlled by exchange 28 sends a confirmation (“Confirmation T”) back to the seller 26. Also on day T, a buyer for the first delivery date who is also the seller for the second delivery date (B1) 30 places an order (Order T) with the computer controlled by exchange 28 and the computer controlled by exchange 28 sends that buyer 30 a confirmation on the same day.

A computer controlled by a custodian for S1 32 has custody of the securities that S1 26 is selling. At time T+X the computer controlled by a custodian for S1 32 transfers the securities to the computer controlled by intermediate custodian 34. B1's custodian 36 sends the money of B1 to the computer controlled by a Seller's custodian 32 at T+X.

Also, on day T, a buyer for the second delivery date (B2) 38 places an order with the exchange 28 and the computer controlled by exchange 28 sends B2 38 a confirmation on the same day.

At time T+X+Y the intermediate custodian 34 transfers securities to a custodian for B2 40 and on the same day the computer controlled by custodian for B2 40 transfers money to B1's custodian. In FIG. 2 the seller 26 is a seller for the first delivery date (T+X) and the first buyer 30 is a buyer for the first delivery date (T+X), while the second buyer 38 is a buyer for the second delivery date T+X+Y. In brief, in the embodiment of FIG. 2, the second buyer buys the securities on the second delivery date, instead of the original seller buying the securities back.

Referring now to FIG. 3, a three-party transaction is shown with one buyer and two different sellers on the contra-sides of the transaction. This enables the first seller to dispose of the security prior to the record date for the corporate action but to not be locked into a re-purchase of the security. A single buyer, however, would obtain ownership of the security on the record date but be locked into a sale for delivery after the record date. In more detail, FIG. 3 shows a system 42 where the first seller (S1) 44, places an order at a time T with an computer controlled by an exchange 46. This order is represented by the arrow labeled “Order T.” T is the time of the transaction. Also on the same day T, the computer controlled by the exchange 46 sends a confirmation (“Confirmation T”) back to the seller first seller 44. The first seller's order is to sell the securities on the first delivery date T+X. The first seller has a computer controlled by custodian 56 that holds the first seller's money.

Also on day T, a buyer (B) 48 places an order (Order T) with the computer controlled by the exchange 46 and the computer controlled by the exchange 46 sends the buyer 48 a confirmation on the same day, T. The first buyer's order is to purchase the securities on the first delivery date T+X. The buyer's funds are held by the computer controlled by buyer's custodian 50, which transfers funds to the computer controlled by custodian for S1 56 at T+X. Also on day T, the second seller S2, shown at 51 places an order with the computer controlled by exchange 46 and the computer controlled by exchange 46 sends a confirmation to the second seller S2. The second seller's order is to sell the securities on the second delivery date T+X+Y.

Also at T+X a computer controlled by custodian for the first seller S1 transfers securities to the intermediate custodian 58.

At time T+X+Y the computer controlled by custodian for the second seller 52 transfers securities to the custodian for the first seller 56. On the same day, the computer controlled by first seller's custodian 56 transfers money to the computer controlled by custodian for the second seller 52. It should be noted that segregation is performed by the custodians and particularly the intermediate custodian in order to make sure that the securities which have been sold will be available for delivery.

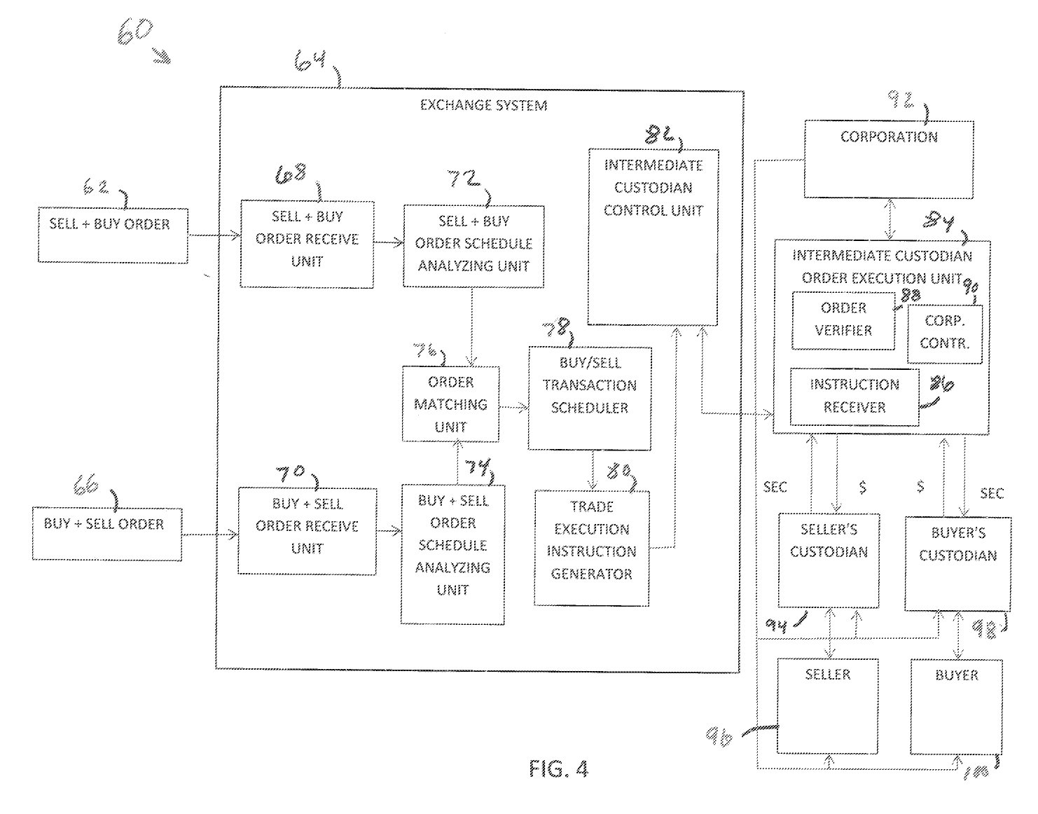

Referring now to FIG. 4 there is shown a system 64 comprising an arrangement of computers for trading with multiple delivery dates. This system corresponds to the two-party embodiment of FIG. 1A with a single buyer and a single seller. A seller, corresponding to the seller in FIG. 1, issues a sell and buy order 62 which is sent to a computer controlled by an exchange 64. The computer controlled by exchange 64 is a special purpose computer that performs the functions of the exchange as described above in connection with FIG. 1. A buyer, corresponding to the buyer in FIG. 1 issues a buy and sell order 66 which is sent to the computer controlled by exchange 64. The sell and buy order 62 is received and processed by a sell and buy order receive unit 68 in the computer controlled by exchange 64. The buy and sell order is received and processed by a buy and sell order receive unit 70.

A sell and buy order schedule analyzing unit 72 analyzes the order and performs such functions as determining the availability of securities to be delivered. Similarly, a buy and sell order schedule analyzing unit 74 analyzes the order and performs such functions as determining the availability of securities to be delivered. An order matching 76 unit receives the information from the analyzing units 72, 74 and finds a match between the two. This insures that the pricing and availability of the securities match the tow orders 62,64 for delivery of the securities at the time T+X and T+X+Y.

Once the match is confirmed, the order matching unit 76 sends the information to the buy/sell transaction scheduler 78, which establishes a schedule for the transaction. This information is then sent to the trade execution instruction generator 80, which creates the instructions to be used by the intermediate custodian. The trade execution instruction generator 80 sends the instructions to an intermediate custodian control unit 82, which sends the instructions to the intermediate custodian order consummation unit 84. The intermediate custodian control unit handles other functions, such as overall communications and control with the intermediate custodian order consummation unit 84.

The computer controlled by intermediate custodian order consummation unit 84 is a special purpose computer that performs the functions of the intermediate custodian, as described above in connection with FIG. 1. The intermediate custodian order consummation unit 84 includes an instruction receiver 86 for receiving instructions from the intermediate custodian control unit 82. The intermediate custodian order consummation unit 84 includes an order verifier 88 for verifying orders. Such verification can be sent to the exchange system 64 in response to instructions received from the exchange system 64. The intermediate custodian order consummation unit 84 also includes a corporation control unit 90 for issuing information regarding change of securities ownership to a corporation 92 and for receiving verifications back from the corporation 92.

A seller's custodian computer system 94 is a computer that performs the functions of the seller's custodian as described above in connection with FIG. 1. The seller's custodian computer 94 is in communication with the seller 96. A buyer's custodian computer system 98 is a computer that performs the functions of the buyer's custodian as described above in connection with FIG. 1. The buyer's custodian computer 94 is in communication with the buyer 100.

When the intermediate custodian order consummation unit 84 transfers ownership of a security, the corporation control unit 90 sends the information about the new owner to the corporation 92. This insures that the buyer 100 gets the benefit of the corporate action on the desired date. A confirmation of the ownership may be sent by the corporation 92 to the buyer's custodian 98 or directly to the buyer.

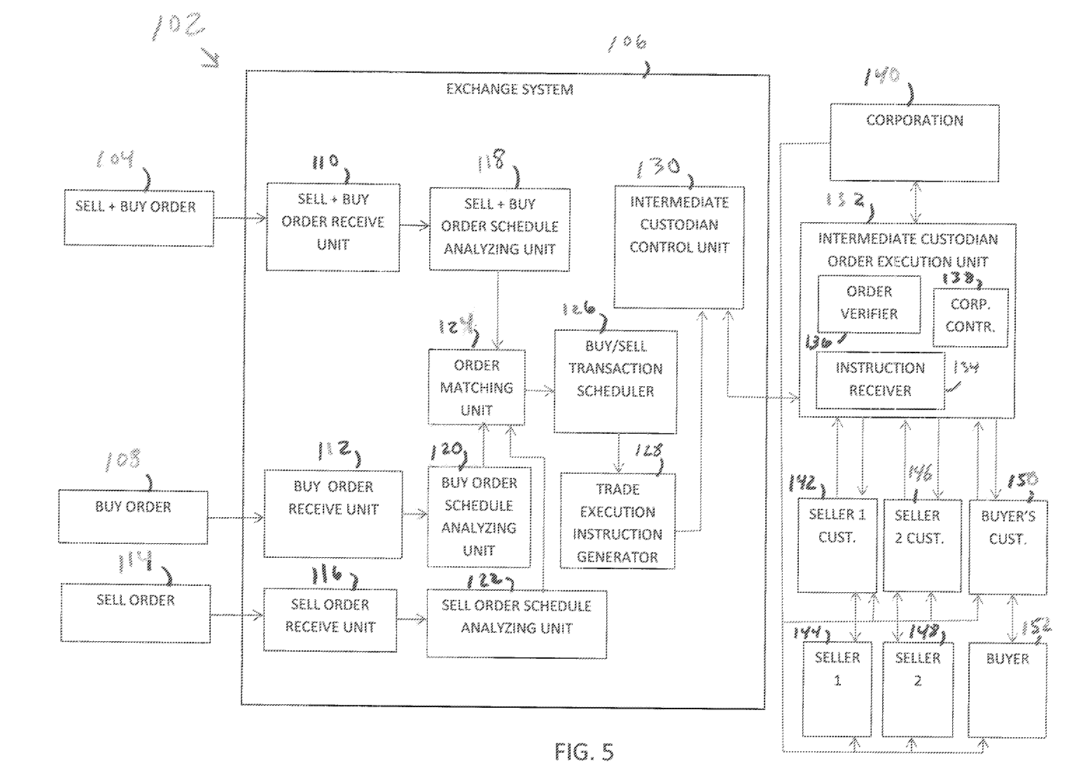

Referring now to FIG. 5 there is shown a system 102 comprising an arrangement of computers for trading with multiple delivery dates. This system corresponds to the three-party embodiment of FIG. 3 with a single buyer and two sellers. A seller, corresponding to the seller S1 in FIG. 3, issues a sell and buy order 104 which is sent to computer controlled by a computer controlled by an exchange 106. The computer controlled by a computer controlled by an exchange 106 is a special purpose computer that performs the functions of the exchange as described above in connection with FIG. 3. A buyer, corresponding to the buyer in FIG. 3 issues a buy order 108 which is sent to the computer controlled by an exchange 106. The sell and buy order 104 is received and processed by a sell and buy order receive unit 110 in the exchange system 64. A buy order 108 is received and processed by a buy and sell order receive unit 70. A sell order 114 is issued by a second seller (corresponding to S2 in FIG. 2), which is received and processed by a sell order receive unit 116 in the computer controlled by exchange 106.

A sell and buy order schedule analyzing unit 118 analyzes the order and performs such functions as determining the availability of securities to be delivered. Similarly, a buy order schedule analyzing unit 120 analyzes the order and performs such functions as determining the availability of securities to be delivered. Also, a sell order schedule analyzing unit 122 analyzes the order and performs such functions as determining the availability of securities to be delivered. An order matching unit 124 receives the information from the analyzing units 118, 120, 122 and finds a match between the three. This insures that the pricing and availability of the securities match the three orders 104, 108, and 114 for delivery of the securities at the time T+X and T+X+Y.

Once the match is confirmed, the order matching unit 124 sends the information to the buy/sell transaction scheduler 126, which establishes a schedule for the transaction. This information is then sent to the trade consummation instruction generator 128, which creates the instructions to be used by the intermediate custodian. The trade consummation instruction generator 128 sends the instructions to an intermediate custodian control unit 130, which sends the instructions to the intermediate custodian order consummation unit 132. The intermediate custodian control unit 130 handles other functions, such as overall communications and control with the intermediate custodian order consummation unit 132.

The intermediate custodian order consummation unit 132 is a special purpose computer that performs the functions of the intermediate custodian, as described above in connection with FIG. 3. The intermediate custodian order consummation unit 132 includes an instruction receiver 134 for receiving instructions from the intermediate custodian control unit 130. The intermediate custodian order consummation unit 132 includes an order verifier 136 for verifying orders. Such verification can be sent to the computer controlled by exchange 106 in response to instructions received from the computer controlled by exchange 106. The intermediate custodian order consummation unit 132 also includes a corporation control unit 138 for issuing information regarding change of securities ownership to a computer controlled by a corporation 140 and for receiving verifications back from the computer controlled by a corporation 140.

A seller 1 custodian computer system 142 is a computer that performs the functions of the seller's custodian as described above in connection with FIG. 3. The seller's custodian computer 142 is in communication with the seller 144. A seller 2 custodian computer system 146 is a computer that performs the functions of the seller S2 custodian as described above in connection with FIG. 3. The seller 2 custodian computer 146 is in communication with the seller 2 148. A buyer's custodian computer system 150 is a computer that performs the functions of the buyer's custodian as described above in connection with FIG. 3. The buyer's custodian computer 150 is in communication with the buyer 152.

When the intermediate custodian order consummation unit 132 transfers ownership of a security, the corporation control unit 138 sends the information about the new owner to the computer controlled by a corporation 140. This insures that the buyer 152 gets the benefit of the corporate action on the desired date. A confirmation of the ownership may be sent by the computer controlled by a corporation 140 to the buyer's custodian 150 or directly to the buyer 152.

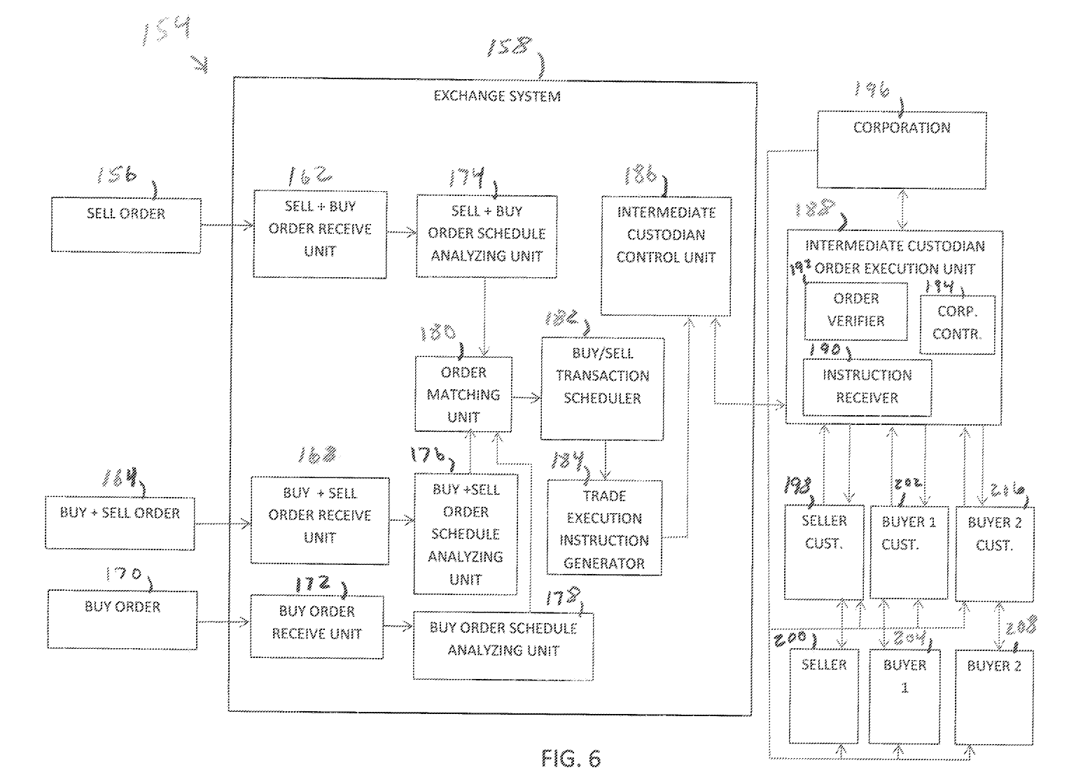

Referring now to FIG. 6 there is shown a system 154 comprising an arrangement of computers for trading with multiple delivery dates. This system corresponds to the three-party embodiment of FIG. 2 with a single seller and two buyers. A seller, corresponding to the seller S1 in FIG. 2, issues a sell order 156 which is sent to a computer controlled by an computer controlled by an exchange 158. The computer controlled by exchange 158 is a special purpose computer that performs the functions of the exchange as described above in connection with FIG. 2. The sell order 156 is received and processed by a sell order receive unit 162 in the computer controlled by exchange 158. A buy and sell order 164 is received and processed by a buy and sell order receive unit 168. A buy order 170 is issued by a second buyer (corresponding to B2 in FIG. 2), which is received and processed by a buy order receive unit 172 in the computer controlled by exchange 158.

A sell and buy order schedule analyzing unit 174 analyzes the order and performs such functions as determining the availability of securities to be delivered. Similarly, a buy and sell order schedule analyzing unit 176 analyzes the order received and performs such functions as determining the availability of securities to be delivered. Also, a buy order schedule analyzing unit 178 analyzes the order received and performs such functions as determining the availability of securities to be delivered. An order matching unit 180 receives the information from the analyzing units 174, 176, 178 and finds a match between the three. This insures that the pricing and availability of the securities match the three orders 156, 164, and 170 for delivery of the securities at the time T+X and T+X+Y.

Once the match is confirmed, the order matching unit 180 sends the information to the buy/sell transaction scheduler 182, which establishes a schedule for the transaction. This information is then sent to the trade execution instruction generator 184, which creates the instructions to be used by the intermediate custodian. The trade execution instruction generator 184 sends the instructions to an intermediate custodian control unit 186, which sends the instructions to the intermediate custodian order consummation unit 188. The intermediate custodian control unit 186 handles other functions, such as overall communications and control with the intermediate custodian order consummation unit 188.

The intermediate custodian order consummation unit 188 is a special purpose computer that performs the functions of the intermediate custodian, as described above in connection with FIG. 2. The intermediate custodian order consummation unit 188 includes an instruction receiver 190 for receiving instructions from the intermediate custodian control unit 186. The intermediate custodian order consummation unit 188 includes an order verifier 192 for verifying orders. Such verification can be sent to the computer controlled by exchange 158 in response to instructions received from the computer controlled by exchange 158. The intermediate custodian order consummation unit 188 also includes a corporation control unit 194 for issuing information regarding change of securities ownership to a computer controlled by a computer controlled by a corporation 196 and for receiving verifications back from the computer controlled by a computer controlled by a corporation 196.

A seller 1 custodian computer system 198 is a computer that performs the functions of the seller's custodian as described above in connection with FIG. 2. The seller's custodian computer 198 is in communication with the seller 200. A buyer 1 custodian computer system 202 is a computer that performs the functions of the seller buyer B1 custodian as described above in connection with FIG. 2. The buyer 1 custodian computer 202 is in communication with the buyer 1 204. A buyer 2 custodian computer system 206 is a computer that performs the functions of the buyer 2 custodian as described above in connection with FIG. 2. The buyer 2 custodian computer 206 is in communication with the buyer 2 208.

When the intermediate custodian order consummation unit 188 transfers ownership of a security, the corporation control unit 194 sends the information about the new owner to the computer controlled by a computer controlled by a corporation 196. This insures that the buyer, such as buyer 1 204, gets the benefit of the corporate action on the desired date. A confirmation of the ownership may be sent by the computer controlled by a computer controlled by a corporation 196 to the buyer's custodian 202 or directly to the buyer 204.

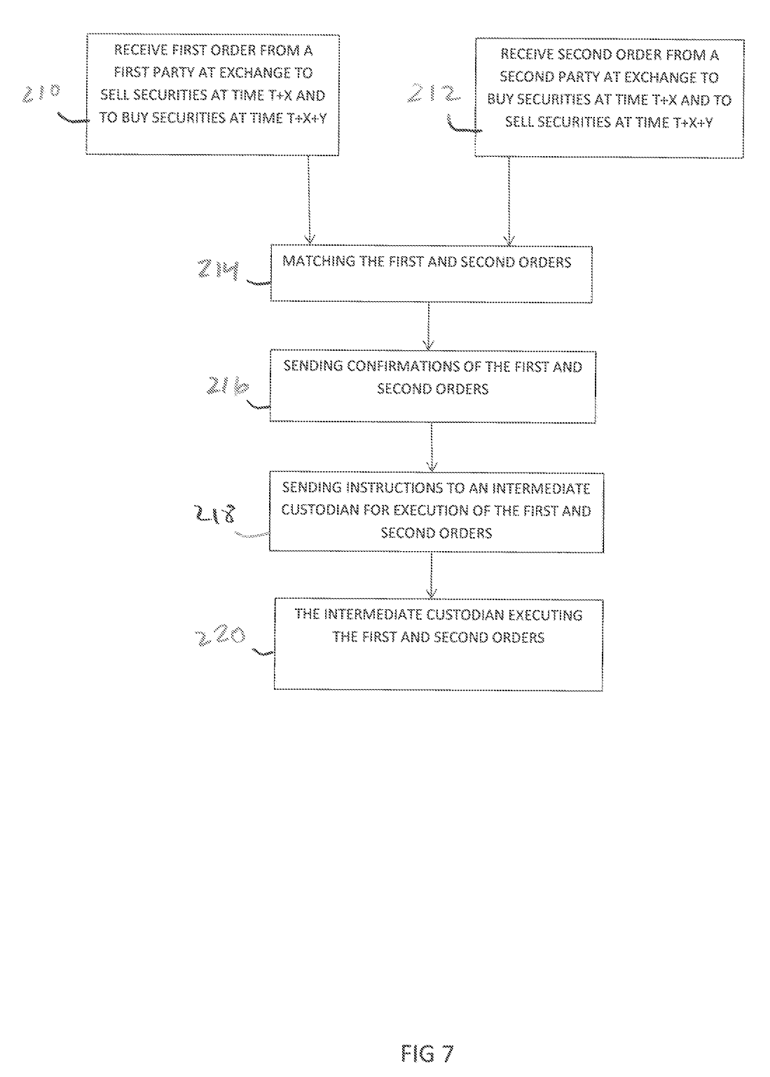

FIG. 7 is a flowchart of a computer implemented process for trading with multiple delivery dates in accordance with one embodiment of the invention. This method corresponds to the two-party transaction described in FIG. 1. At step 210, a first order from a first party is received at an exchange to sell securities at a time T+X and to buy the securities at time T+X+Y. At step 212 a second order is received from a second party at an exchange to buy securities at time T=X and to sell securities at time T+X+Y. At step 214 the first and second orders are matched. At step 216 confirmations of the two orders are sent. At step 218 instructions are sent to an intermediate custodian for execution of the first and second orders. At step 220 the intermediate custodian executes the first and second orders.

As can be seen from the above disclosure, the various embodiments provide ways to facilitate trading with multiple delivery dates. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

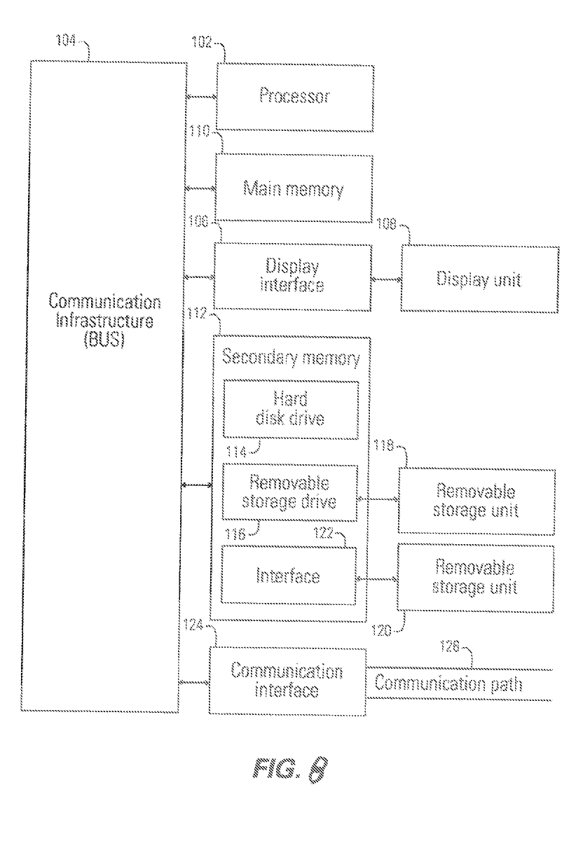

FIG. 8 is a high level block diagram showing an information processing system useful for implementing one embodiment of the present invention. The computer system includes one or more processors, such as processor 102. The processor 102 is connected to a communication infrastructure 104 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program cartridge and cartridge interface (such as that found in video game devices), a removable memory chip (such as an EPROM, or PROM) and associated socket, and other removable storage units 120 and interfaces 122 which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via communications interface 124. Such computer programs, when executed, enable the computer system to perform the features of the present invention as discussed herein. In particular, the computer programs, when executed, enable the processor 102 to perform the features of the computer system. Accordingly, such computer programs represent controllers of the computer system.

From the above description, it can be seen that the present invention provides a system, computer program product, and method for implementing the embodiments of the invention. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of communicating between multiple computers to implement the trading of securities comprising:
receiving a first order from a first party at an exchange at a time T to sell securities and buy back the securities through the exchange, wherein the first order contains a schedule that defines a time T+X for the delivery of securities sold by the first party to occur and a time T+X+Y for the delivery of the reverse of the order to occur, such that at time T+X+Y the same securities are bought back by the first party;
receiving a second order from a second party at the exchange to buy the securities and to sell the same securities according to a second schedule such that at time T+X the second party buys the securities and at time T+X+Y the second party sells the securities;
matching the first and second orders;
sending a confirmation of the first and second orders to the first and second parties;
sending instructions to an intermediate custodian for implementation of the first and second schedules; and
the intermediate custodian executing the first and second orders on behalf of the first and second parties according to the instructions, wherein the securities are delivered to the second party at a time T+X and the securities are delivered to the first party at time T+X+Y.

2. The method according to claim 1 wherein the order to sell (or buy) securities is a limit order.

3. The method according to claim 2 wherein the limit order is defined in terms of a difference D between the transaction price for the sale (or purchase) and the price for the purchase (or sale).

4. The method according to claim 1 where Y may be a positive or a negative number.

5. The method according to claim 1 where D may be a positive or a negative number.

6. The method according to claim 1 further comprising:
identifying the availability of the security to be delivered upon receipt of the order; and
the intermediate custodial entity comprising at least one of: a) an account for the exchange in which the exchange keeps separate custody of securities for the beneficial ownership of the first party for delivery in completed transactions; b) an account for the first party for which the exchange receives verification or other satisfactory assurance of continuous availability; or c) a custodial account which provides beneficial ownership for the first party, but for which the exchange receives verification or satisfactory assurance of continuous availability.

7. The method according to claim 6 wherein the identifying the availability is performed by at least one of: a trader, a broker, or a custodian.

8. The method according to claim 2, wherein an investor enters a single difference for buying (selling) a security for delivery at time T and selling (buying) the security at time T+1 by security for delivery at time T and selling (buying) the security at time T+1, and that single difference is made available to a contra party to sell (buy) the security for delivery at time T and selling (buying) the security at time T+1 and wherein market orders are filled at the lowest difference that was entered but which has not been cancelled or filled.

9. The method according to claim 8, wherein the single difference that was entered by an investor is displayed and the display shows the difference along with the number of shares which are available at that difference.

10. The method according to claim 9 by which multiple differences are displayed on the same stock and the display is arrayed according to the amount of the quoted difference.

11. The method according to claim 1 wherein securities are transferred to an intermediate custodian at time T+X, and the intermediate custodian transfers those to a different custodian specified by the seller at time T+X+Y, and wherein the intermediate custodian is controlled by the exchange or has arrangements satisfactory to the exchange to guarantee the availability of the securities to be delivered to the seller at time T+X+Y.

12. The method according to claim 1 wherein the method includes a three-party transaction wherein one party buys for delivery on the earlier date and sells for delivery on the later date, a second party that only sells for delivery on the earlier date, and a third party that only buys for delivery on the later date.

13. The method according to claim 1 wherein the method includes a three-party transaction wherein one party sells for delivery on the earlier date and buys for delivery on the later date, a second party only buys for delivery on the earlier date, and a third party only sells for delivery on the later date.

14. The method according to claim 1 wherein the custodial entity has an agreement with the exchange to not sell, lend, or otherwise transfer or encumber securities which have been delivered to it at time T+X but which are required for a second delivery at time T+X+Y.

15. The method according to claim 1 wherein the custodial entity reports to an entity which issued the security that the second party is the holder of record at time T+X.

16. A method of trading securities comprising:
placing an order by a seller at a time T to sell and buy securities through an exchange, wherein the order containing a schedule that defines a time T+X for the sale to occur and a time T+X+Y for the securities to be repurchased by the seller;
sending a confirmation of the order from the exchange to the seller;
the exchange receiving an order from a buyer to buy the securities and sell the securities according to the schedule and sending a confirmation of the order to the buyer;
the exchange instructing an intermediate custodian to make deliver, thereby consummating the order placed by the seller according to the schedule; and
the intermediate custodian consummating the order on behalf of the seller and buyer, wherein the securities are delivered to the buyer at date T+X and delivered to the seller at time T+X+Y.

17. A system for trading securities comprising:
first receiver unit for receiving a first order from a first party at an exchange at a time T to sell securities and buy back securities through the exchange, wherein the first order contains a schedule that defines a time T+X for the delivery of securities sold to occur and a time T+X+Y for the delivery of the reverse of the order to occur, such that at time T+X+Y the same securities are bought back by the first party;
second receiver unit for receiving a second order from a second party at the exchange to buy securities and to sell the same securities according to a second schedule, such that at time T+X the second party buys the securities and at time T+X+Y the second party sells the securities;
order matching unit for analyzing the first and second orders and finding the existence of a match between the securities and the first and second schedules;
order scheduler for scheduling the transactions specified in the first and second orders as matched by the order matching unit;
trade execution instruction generator for generating and transmitting instructions to execute the first and second orders according to the first and second schedules;
wherein the transmitted instructions are sent to a custodial entity which executes the first and second orders according to the first and second schedules.
